(19) United States
(12) Patent Application Publication
(10) Pub. No.: US 2025/0330843 A1
(43) Pub. Date: Oct. 23, 2025

(54) METHOD AND SYSTEM FOR SENSOR ALARM REPORTING AND UE-TO-UE COMMUNICATION IN RADIO ACCESS NETWORKS

(71) Applicant: Badawi Yamine, Beirut (LB)

(72) Inventor: Badawi Yamine, Beirut (LB)

(21) Appl. No.: 18/817,139

(22) Filed: Aug. 27, 2024

(30) Foreign Application Priority Data
Apr. 22, 2024 (IN) 202411031855

(51) Int. Cl. H04W 24/04; H04W 4/90; H04W 92/18

(52) U.S. Cl. CPC H04W 24/04; H04W 4/90; H04W 92/18

(57) ABSTRACT

The present disclosure provides a method (100) and a system (200) for reporting a sensor alarm and facilitating UE-to-UE communication in a radio access network (RAN). The method (100) includes the radio access network receiving (102) within a predefined margin, an early notification of the sensor alarm from a first user equipment (UE), terminating (104) one or more scheduled or ongoing network activities impacting call performance of a UE upon receipt of the early notification of the sensor alarm and initiating (106) tracking of reachability of the first UE by the RAN. Further, the method (100) includes continuing (108) tracking of reachability of the first UE by the RAN, where if the first UE remains reachable no further action is taken by the RAN, and if the first UE becomes unreachable send a command from the RAN to one or more surrounding UEs instructing them to activate UE-to-UE wireless communication.

### TECHNICAL FIELD

The present disclosure relates, in general, to wireless communication systems. More particularly, it relates to a system and method to report a sensor alarm and facilitate UE-to-UE communication in a radio access network (RAN).

### BACKGROUND

The following description of the related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admission of the prior art.

In a wireless network, the reliability and continuity of electronic equipment are paramount, yet inevitable disruptions, in the form of cell outages, pose significant challenges. These outages can occur unexpectedly due to hardware or software malfunctions, or they can be planned for maintenance or upgrades. Such disruptions can have far-reaching implications, particularly in scenarios where critical sensor alarms need to be communicated, via the wireless network, promptly to designated entities, such as emergency response teams or healthcare professionals.

The integration of sensors into wireless networks introduces another layer of complexity to cell outage scenarios. Sensors, whether embedded within mobile devices or deployed as standalone units, play a crucial role in detecting and relaying alarm information. However, when an outage occurs, rendering sensors unreachable by the wireless network, the ability to transmit alarm notifications becomes compromised. This presents a significant challenge, especially when time-sensitive alarms, such as gas leakages or medical emergencies, need immediate attention. In the rest of this document, when we utilize User Equipment (UE) that means it is a UE that might be used by a sensor to communicate with the wireless network.

There currently exists no software component deployed at the UE tasked with two critical functions of logging locations and timestamps where the UE encounters recurring cell outages or degradation in radio network performance and recording locations and timestamps of sensor alarms triggered at the UE end. The absence of such a component means that when a sensor alarm activates at a particular location (X) and timestamp (timestamp1), there's no system in place to determine whether there's a likelihood of the UE experiencing either cell outage or radio network degradation at that same location and time.

Actually, a sensor alarm is sent to a preconfigured destination. In one example a biological sensor attached to the body of a patient might be preconfigured to send a notification to the mobile phone of a doctor or a hospital. In a second example, a fire sensor alarm might be preconfigured to send a notification to a firefighter station. In both the above examples as well as in all other examples, the radio access network will not be aware of the exchange of these sensor alarm notifications. As a consequence, any planned network activities that could impact the subscribers' calls might proceed at the time of occurrence of these sensor alarm notifications and this is a problem as the subscribers impacted by these alarms might not be able to perform a call.

Furthermore, traditional communication channels between UEs and the wireless network may become unavailable during outages, necessitating alternative means of communication. User-to-user (UE-to-UE) wireless communication, also known as device-to-device (D2D) communication, emerges as a viable solution in such scenarios. Leveraging this capability enables UEs to establish direct communication channels, bypassing the network infrastructure, and facilitating the exchange of critical information, including sensor alarms, among peers.

However, despite the potential of UE-to-UE communication to bridge communication gaps during outages, several challenges remain unresolved. For instance, there is a lack of standardized protocols dictating the duration for which UE-to-UE communication should remain active once initiated. Determining an optimal timeframe for such communication is crucial to balancing the need for continuous connectivity with energy efficiency and resource utilization. Additionally, not all UE-to-UE communication technologies may be activated uniformly when an UE is left out of coverage, further complicating the communication landscape.

There, is therefore, a need to provide an optimum solution that can obviate the above-mentioned limitations and provide an efficient and improved solution for determining the duration of UE-to-UE communication activation and selecting the appropriate wireless communication technologies for activation.

### Objects of the Present Disclosure

An object of the present disclosure is to provide an AI (Artificial Intelligence) and ML (Machine Learning) entity at the UE side that enables the UE to guess whether, around the time the UE has reported to the radio access network an early sensor alarm notification, there is an ongoing network activity that could impact call performance at the radio access side.

An object of the present disclosure is to provide a method that ensures a timely response to sensor alarms by promptly terminating network activities impacting call performance upon receiving early notifications.

An object of the present disclosure is to provide a method that enables monitoring of the reachability of an UE that has reported an early sensor alarm notification to ensure ongoing communication capabilities, which are crucial for transmitting critical alarm information and facilitating coordinated responses.

An object of the present disclosure is to provide a method that aims to leverage UE-to-UE wireless communication technologies as an alternative communication channel in scenarios where the first UE becomes unreachable.

An object of the present disclosure is to provide a method where after receiving a sensor alarm clearance from a UE, the radio access network, on one hand, resumes any activity that was halted due to the reception of an earlier sensor alarm notification and on the other hand it disables any ongoing related UE-to-UE wireless communication.

An object of the present disclosure is to provide an efficient solution that determines the duration of UE-to-UE communication activation and selects the appropriate wireless communication technologies for activation.

### SUMMARY

Aspects of the present disclosure relate to wireless communication systems. More particularly, it relates to a system and method to report a sensor alarm notification to a radio access network and facilitate UE-to-UE communication in a radio access network (RAN).

According to an aspect, the present disclosure relates to a method for reporting a sensor alarm and facilitating UE-to-UE communication in a radio access network (RAN). The method includes a radio access network receiving within a predefined margin, an early notification of the sensor alarm from a first user equipment (UE), terminating one or more scheduled or ongoing network activities impacting call performance of a UE upon receipt of the early notification of the sensor alarm and initiating tracking of reachability of the first UE by the RAN. Further, the method includes continuing the tracking of the reachability of the first UE by the RAN, where if the first UE remains reachable no further action is taken by the RAN, and if the first UE becomes unreachable send a command from the RAN to one or more surrounding UEs instructing them to activate UE-to-UE wireless communication.

In an aspect, the early notification of a critical sensor alarm is reported to the radio access network based on one or more predicted occurrences of sensor alarm coinciding with presumed RAN activities or upon reaching predetermined thresholds of one or more sensor alarm levels.

In an aspect, the activation of UE-to-UE wireless communication technologies comprises activating available technologies on the first UE and transmitting a command by the radio access network to the one or more surrounding UEs specifying the type of communication technology to activate.

In an aspect, the first UE is considered unreachable if it fails to respond to repeated paging requests in idle mode or loses radio link connection in connected mode.

In an aspect, the RAN comprises a cell, a radio node, and an Operation Support System (OSS) having one or more software entities for tracking the reachability of the UE that has reported sensor alarm.

In an aspect, the termination of a reported sensor alarm triggers a clearance notification from the UE to the network, either immediately or after a predefined period.

In an aspect, clearance of the sensor alarm triggers a second sensor alarm notification, prompting network activity resumption and UE-to-UE communication deactivation.

In an aspect, UE-to-UE wireless communication is activated in one or more neighboring cells on all the UEs being served by the one or more neighboring cells or at the UEs located at a border of a first area of a first cell and when an outage on the first cell is recovered, UE-to-UE wireless communication is deactivated on all the UEs in one or more neighboring cells of the first cell.

In an aspect, activation and deactivation of multiple UE-to-UE communication technologies occur sequentially or simultaneously based on a set of predefined patterns or timers.

In another aspect, the present disclosure pertains to a system to report a sensor alarm to a radio access network and facilitate UE-to-UE communication in a radio access network (RAN). The method includes a receiver configured to receive an early notification of the sensor alarm from a first user equipment (UE) within a predefined margin, a communication controller in communication with the first UE and configured to terminate one or more scheduled or ongoing network activities impacting call performance of a UE upon receipt of the early notification of the sensor alarm and initiate and maintain tracking of the reachability of the first UE by the radio access network. Further, the system includes a transmitter configured to send a command from the radio access network to one or more surrounding UEs instructing activation of UE-to-UE wireless communication upon unreachability of the first UE.

Various objects, features, aspects and advantages of the inventive subject matter will become more apparent from the following detailed description of preferred embodiments, along with accompanying drawing figures in which like numerals represent like components.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure, and together with the description, serve to explain the principles of the present disclosure.

FIG. 1 illustrates a flow diagram of a method for reporting a sensor alarm to a radio access network and facilitating UE-to-UE communication in a radio access network (RAN), in accordance with an embodiment of the present disclosure.

FIG. 2 illustrates an exemplary representation for the reporting of a sensor alarm with existing solutions, in accordance with an embodiment of the present disclosure.

FIG. 3 illustrates an exemplary representation for defining a new sensor alarm to trigger a radio access network reaction by the proposed method, in accordance with an embodiment of the present disclosure.

FIG. 4 illustrates an exemplary representation of the steps for reporting a new sensor alarm by the proposed method, in accordance with an embodiment of the present disclosure.

FIG. 5 illustrates an exemplary representation of the connection of a new link to a software entity on the OSS (Operations Support System) that tracks the reachability of the UE to the server of the sensor mobile application, in accordance with an embodiment of the present disclosure.

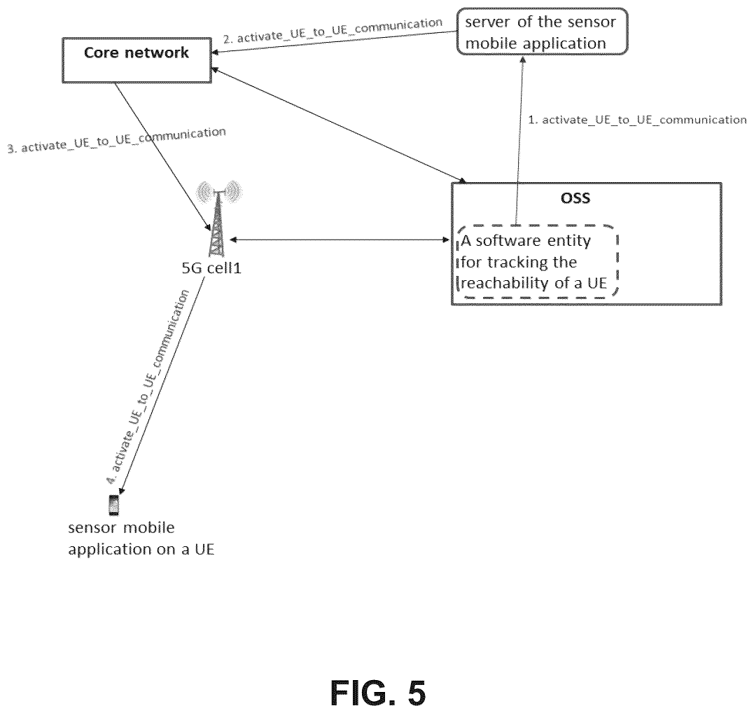

FIG. 6 illustrates an exemplary representation of steps for network reaction at the receipt of a sensor alarm by the proposed method, in accordance with an embodiment of the present disclosure.

FIG. 7 illustrates an exemplary representation of steps for a network reaction after receiving the clearance of a sensor alarm by the proposed method, in accordance with an embodiment of the present disclosure.

FIG. 8 illustrates an exemplary representation of steps for activation of UE-to-UE wireless communication each time a cell goes down, in accordance with an embodiment of the present disclosure.

FIG. 9 illustrates an exemplary representation of steps to instruct the UEs about the duration to activate UE-to-UE wireless communication, in accordance with an embodiment of the present disclosure.

FIG. 10 illustrates an exemplary block diagram of a system to control a sensor alarm and facilitate UE-to-UE communication in a radio access network (RAN), in accordance with an embodiment of the present disclosure.

### DETAILED DESCRIPTION

The following is a detailed description of embodiments of the disclosure depicted in the accompanying drawings. The embodiments are in such detail as to communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

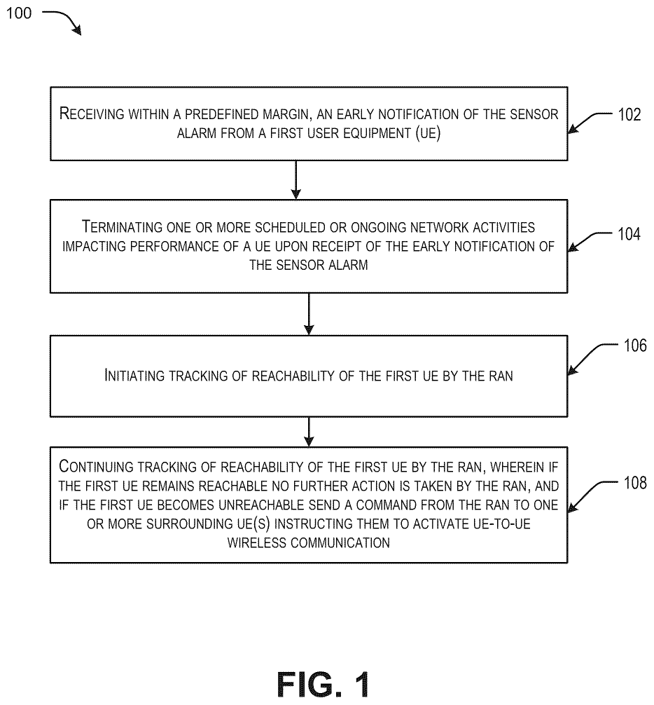

FIG. 1 illustrates a flow diagram of a method for controlling a sensor alarm and facilitating UE-to-UE communication in a radio access network (RAN), in accordance with an embodiment of the present disclosure.

Referring to FIG. 1, in an embodiment, a method 100 for reporting a sensor alarm and facilitating UE-to-UE communication in a radio access network (RAN) is disclosed. Method 100 can include step 102 of receiving within a predefined margin, an early notification of the sensor alarm from a first user equipment (UE). In addition, the method 100 can include step 104 of terminating one or more scheduled or ongoing network activities impacting the call performance of an UE upon receipt of the early notification of the sensor alarm. At step 106, the method 100 can include initiating tracking of the reachability of the first UE by the RAN. Further, the method 100 can include step 108 of continuing tracking of reachability of the first UE by the RAN, where if the first UE remains reachable no further action is taken by the RAN, and if the first UE becomes unreachable send a command from the RAN to one or more surrounding UEs instructing them to activate UE-to-UE wireless communication.

In an embodiment, the early notification of the sensor alarm can be triggered based on one or more predicted occurrences of sensor alarm coinciding with presumed RAN activities or upon reaching predetermined thresholds of one or more sensor alarm levels.

In an embodiment, the activation of UE-to-UE wireless communication technologies can include activating available technologies on the first UE and transmitting a command by the radio access network to the one or more surrounding UEs specifying the type of communication technology to activate.

In an embodiment, the first UE can be considered unreachable if it fails to respond to repeated paging requests in idle mode or loses radio link connection in connected mode.

In an embodiment, the RAN can include a cell, a radio node, and an Operation Support System (OSS) having one or more software entities for tracking the reachability of the UE that has reported sensor alarm.

In an embodiment, the termination of a reported sensor alarm can trigger a clearance notification from the UE to the network, either immediately or after a predefined period.

In an embodiment, the clearance of the sensor alarm can trigger a second sensor alarm notification, prompting network activity resumption or UE-to-UE communication deactivation.

In an embodiment, the UE-to-UE wireless communication can be activated in one or more neighboring cells on all the UEs being served by the one or more neighboring cells or at the UEs located at a border of a first area of a first cell and when outage on the first cell is recovered, UE-to-UE wireless communication can be deactivated on all the UEs in one or more neighboring cells of the first cell.

In an embodiment, the activation and deactivation of multiple UE-to-UE communication technologies can occur sequentially or simultaneously based on a set of predefined patterns or timers.

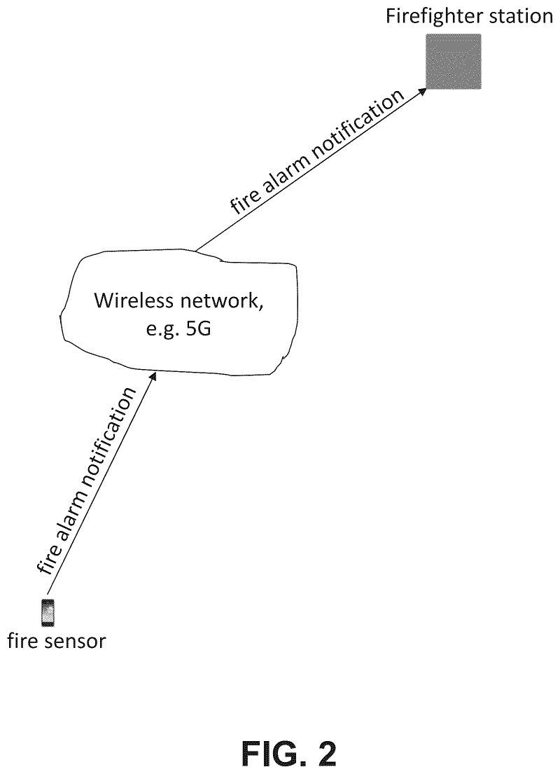

FIG. 2 illustrates an exemplary representation for the reporting of a sensor alarm with existing solutions, in accordance with an embodiment of the present disclosure.

Referring to FIG. 2, in an embodiment, reporting of a sensor alarm with existing solutions is disclosed. When a sensor alarm, being served by one cell, e.g. cell1, is triggered, e.g. a fire alarm has occurred in one area, then the behavior of the sensor is always the same as with the existing solutions that it sends, a notification to a preconfigured destination, e.g. firefighter station or a home resident etc., informing them about that fire alarm.

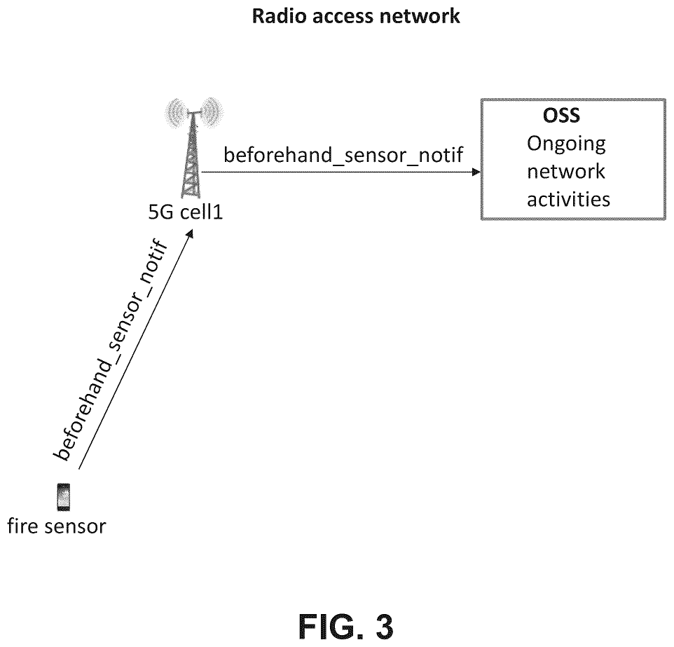

FIG. 3 illustrates an exemplary representation for defining a new sensor alarm to trigger a network reaction by the proposed method, in accordance with an embodiment of the present disclosure.

Referring to FIG. 3, in an embodiment, definition of a new sensor alarm to trigger a network reaction by the proposed method is disclosed. beforehand_sensor_notif can be a new type of alarm notification that is not reported to the preconfigured destination, e.g. firefighter station or a home resident etc., rather it is reported to a different type of destination that is the radio access network and it has different purposes, e.g. halting ongoing radio access network activities which could be like halting a cell outage on cell1 that can be planned around the time of the triggering of beforehand_sensor_notif. The radio access network can include at least the cell, the radio node where the cell is running, the legacy OSS, any new software entity implemented on the OSS, and also any other remote server connected to the OSS. The present disclosure document focuses on OSS utilized in conventional wireless networks, but it's important to highlight that the procedures outlined here are equally applicable to any other type of wireless network's Operations Support System, like the SMO (Service Management and Orchestration) in an Open-RAN wireless network. These procedures are not exclusive to OSS and extend to encompass any Operations Support System across various wireless network types, including SMO.

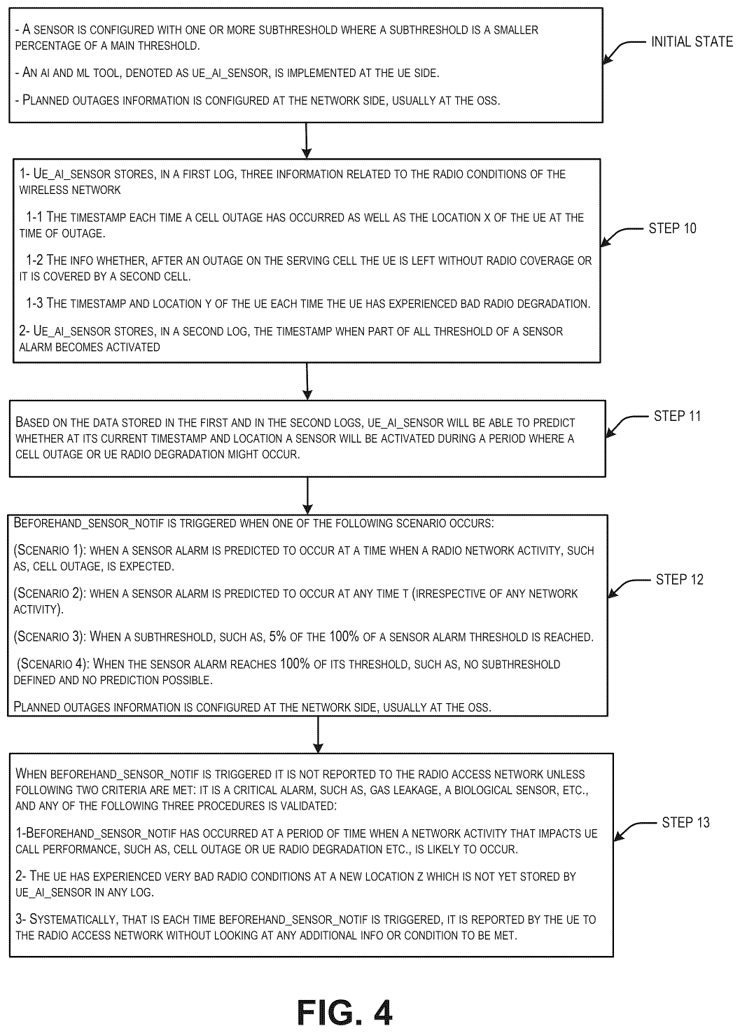

FIG. 4 illustrates an exemplary representation of the steps for reporting of a new sensor alarm by the proposed method, in accordance with an embodiment of the present disclosure.

Referring to FIG. 4, in an embodiment, representation of the steps for reporting of a new sensor alarm by the proposed method is disclosed.

At an initial state:
A sensor can be configured with one or more subthresholds where a subthreshold can be a smaller percentage of a main threshold.
An AI and ML tool, denoted as UE_AI_sensor can be implemented on the UE side.
Planned outages information can be configured on the network side at the Operation Support System (OSS).
   At Step 10: A first role of UE_AI_sensor can be used to store two types of information
   1—For the first type, UE_AI_sensor can store, in a first log, three information related to the radio conditions of the wireless network:
1-1 Each time a cell outage, that is the loss of the radio coverage of the serving cell, has occurred, the timestamp as well as the geographical location X of the UE, at the time of the cell outage, are stored. Note that the location X could be estimated via any existing positioning methods, e.g. by getting GPS (Global Positioning System) coordinates or getting UE radio fingerprint or TA (timing Advance) value where the TA option is valid only if the UE is in connected mode, etc.
1-2 The info whether, after cell1 outage, the UE is left without radio coverage, or it is covered by a second cell where the second cell could be a terrestrial cell running on the same, or on a different, RAT as of cell1 or where the second could be a non-terrestrial cell, e.g. from a satellite communication or a drone, etc.
1-3 The timestamp and location Y of the UE each time the UE has experienced bad radio degradation, e.g. the RSRP (Reference Signal Received Power) at the UE side is below a predefined threshold.
   2—For the second type, UE_AI_sensor stores, in a second log, the timestamp when part or all Threshold of a sensor alarm becomes activated. Note that depending on the type of the sensor, the timestamp of the activation of a sensor alarm,
might be scheduled based on an operator configuration, e.g. in the example of a water or electrical meter sensor the sensor information might be sent based on a preconfigured schedule, e.g. every 1 hour.
Or they might be unpredictable, e.g. a gas leakage, etc.
   At Step 11: Build a third log out of the comparison being made between the first and the second logs. Based on the data stored in the first and in the second logs, UE_AI_sensor will be able to predict whether at its current timestamp and location, a sensor will be activated during a period where a cell outage or radio degradation might occur. However, detecting common information, e.g. the geographical location and timestamp in the two logs, might not be always enough to make the UE take an action, e.g. report a sensor alarm notification to the network. That is why when the common information is met, an optional additional condition has to be validated before the UE takes an action. Such additional conditions could be set by the operator of the wireless network or by the designer of the sensor or by others. Following is an example of the role of the additional conditions.
   Suppose that the margin is configured as being 30 minutes. Suppose that after UE_AI_sensor has made a comparison between the first and the second logs. The following are the two findings:
(common information) UE_AI_sensor has found that the common information criteria between the first and the second logs is met, within the margin of 30 minutes, as follows: Based on the first log, at location X, one UE, e.g. UE10, is experiencing a cell outage, on its serving cell, cell1, every Wednesday at 00h00 am. Based on the second log, a sensor alarm, e.g. a biological sensor, at UE10 at location X, is activated every Tuesday around 11h45 pm.
(additional condition) Suppose that there is only a condition being configured that is the UE has to be left out-of-coverage after UE serving cell outage.
   Suppose that in the first stored log of UE10, after UE10 experiences a cell1 outage every Wednesday at 00h00 am, it is left, at location X, out-of-coverage. Hence in our example of UE10 the condition of the first comparison is being met.
   In the above example as the (common period) and (additional condition) criteria are both met, one UE action might consist of sending a sensor alarm notification to the radio access network. Otherwise, if only one criteria, e.g. the (common period) is met but the (additional condition) is not met that is when UE10 receives, after cell1 outage, a radio coverage from any other cell, e.g. cell2, then the UE action will consist of not sending a sensor alarm notification to the radio access network.

### At Step 12:

As it was mentioned above, beforehand_sensor_notif is a new sensor alarm that is sent to the radio access network and is triggered when one of the following four scenarios occurs:
(Scenario 1): After comparing the information stored in the first and second logs, UE_AI_sensor has found that both criteria, the common information and an optional additional condition, are met.
(Scenario 2): When a sensor alarm has already occurred at time t or it is predicted, at time t1, to occur at a later time t2 (irrespective of any network activity). In other words, in this scenario, UE_AI_sensor will not make any comparison between the first and second log as was the case with the previous scenario.
(Scenario 3): When a subthreshold, e.g. 5%, of the 100% of a sensor alarm threshold is reached. A sensor alarm, e.g. a fire alarm, is sent when a threshold, e.g. denoted here as Thresh1, is triggered.
In this document, depending on the type of sensor, it might be possible to define different sub thresholds, e.g. in one example, subthreshold0 is defined as being 5% of Thresh1, subthreshold1 is defined as being 30% of Thresh1, subthreshold2 is defined at being 50% of Thresh1 and so on. The period to move from one subthresholdX to the following subthresholdY varies depending on the type of the sensor, it could be a very short value, e.g. a few seconds or it could be a large value, e.g. up to a few minutes. Saying that beforehand_sensor_notif is triggered when the lowest subthreshold, subthreshold0 in our example, is reached. This is done so that once beforehand_sensor_notif is sent to the network the reaction, as it will be described in the following steps, is done the soonest as possible.
The difference between scenario 3 and the previous two scenarios 1 & 2, is that with the first two scenarios, the sensor has not detected yet any trace of the alarm substance, e.g. one particular gas or fire etc., and it is just a prediction that after some time the sensor should detect at least a certain amount of such substance. Whereas with scenario 3, it is not about a prediction, it is about the sensor having already started detecting a certain amount of the substance to be measured.
(Scenario 4): When the sensor alarm reaches 100% of its threshold, e.g. case no subthreshold defined and no prediction possible.

### At Step 13:

When beforehand_sensor_notif is triggered, via one of four scenarios described in the previous step, it is not reported to the radio access network unless the following two criteria are met: It is a critical alarm, e.g. gas leakage, a biological sensor etc., and any of the following three procedures are validated:
1—(scenario 1) has occurred, that is beforehand_sensor_notif has occurred at a time when a network activity that impacts UE call performance, e.g. cell outage or UE radio degradation etc., is likely to occur and an optional additional condition is validated.
2—The UE has experienced very bad radio conditions at a new location Z which is not yet stored by UE_AI_sensor in any log.
3—Systematically. That is each time beforehand_sensor_notif is triggered, it is reported by the UE to the network without looking at any additional info or condition to be met.

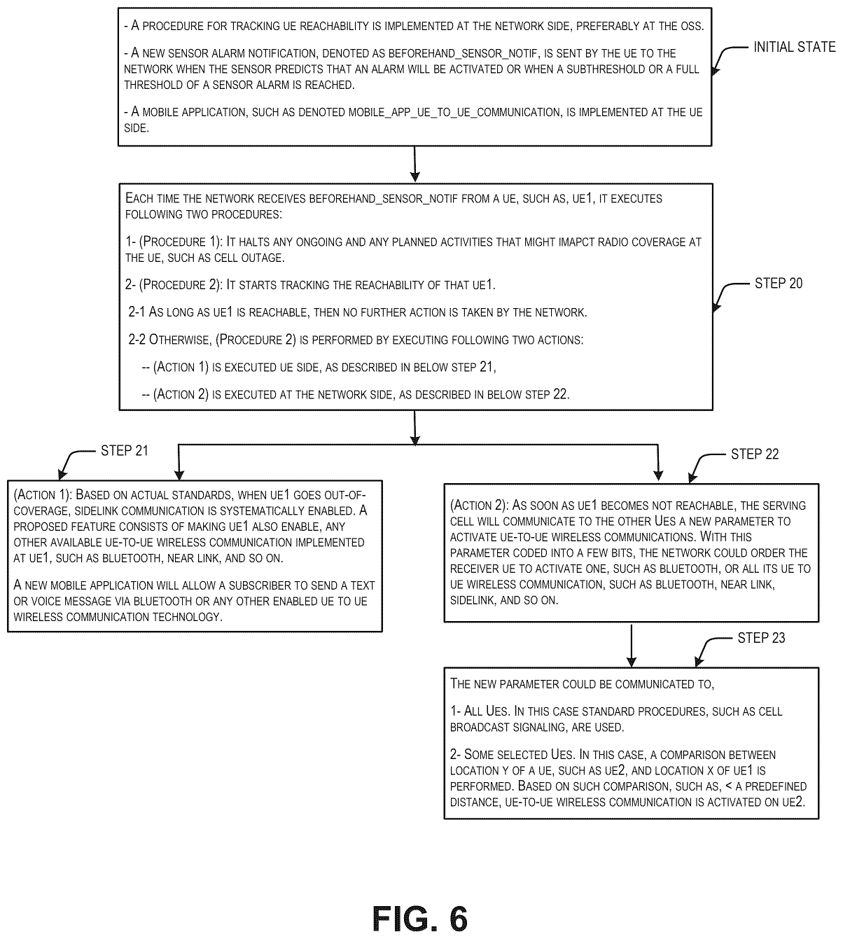

FIG. 6 illustrates an exemplary representation of steps for network reaction at the receipt of a sensor alarm by the proposed method, in accordance with an embodiment of the present disclosure.

Referring to FIG. 6, in an embodiment, steps for network reaction at the receipt of a sensor alarm by the proposed method are disclosed.

At an initial state:
A procedure for tracking UE reachability can be implemented on the network side, preferably at the OSS.
beforehand_sensor_notif, is defined at the UE side.
A mobile application, e.g. mobile_app_UE_to_UE_communication, can be implemented at the UE side.
   At step 20:
   Each time the network receives beforehand_sensor_notif from a UE, e.g. UE1, it can execute the following two procedures:
1—(Procedure 1): Halting any ongoing and planned activities that might impact radio coverage at the UE.
2—(Procedure 2): Enabling UE-to-UE wireless communication in the surroundings of the UE that has reported a critical sensor alarm Following is a description of each of the above two procedures.

### (Procedure 1):

Once the network receives beforehand_sensor_notif at a time, e.g. t1, it will execute one or both of the following two halting procedures in case their occurrence will be executed shortly after the receipt of beforehand_sensor_notif.
1—Halt any upcoming cell planned outage that is close to t1.
2—Halt any network configuration change activity that is being handled by the operator, e.g., the operator might be changing the value of parameters at time t1, e.g. changing the power transmission of the antennas or changing the value of some radio parameters, etc.
   In one example, if beforehand_sensor_notif is received at 11h55 pm, then if within a predefined margin of an outage, e.g. 30 minutes, one or both of the above two activities, cell planned outage or network configuration change, were scheduled shortly, e.g. at 00h00 am, then a first network action consists of halting such activities. Following are two examples of benefits from this type of network reaction.
   1^{st} example of benefit: Take the case where beforehand_sensor_notif contains 5% of the sensor threshold and in our example, it is received by the network at 11h55 pm. If triggering between 5% and 100% of the threshold of the sensor alarm takes more than five minutes then,
With the existing solutions before the sensor alarm reaches its 100% threshold the planned cell outage is executed at 00h00 am and the UE might be left out of coverage. As a consequence, in our example, the UE will not be able to report whether the 100% threshold was reached or not.
With the proposed (procedure 1) such problem is avoided. After the radio access network receives at 11h55 pm, beforehand_sensor_notif, containing 5% of the sensor alarm threshold, it halts the coming cell outage that is planned at 00h00 am. Hence, the UE could report at any time around 00h00 am or after a sensor notification with 100% of the alarm threshold.
   2^{nd} example of benefit: Take the case where beforehand_sensor_notif contains 100% of the sensor. Even though the alarm with 100% has been received at 11h55 pm which is 5 minutes before a planned network activity, e.g. cell outage, avoiding halting such activities is still beneficial. Suppose, that a critical alarm, e.g. a biological sensor on a patient or a fire in an area, has been reported at 11h55 pm, executing the planned cell outage at its scheduled time, 00h00 am as it is the case with existing solutions, might be damaging for the patient or for the subscribers impacted by the fire as they might be left out-of-coverage and they will not be able to communicate with anyone else.

### (Procedure 2):

UE-to-UE wireless communication is triggered only when the UE which has reported beforehand_sensor_notif is no longer reachable by the radio access network. For that purpose, in the following paragraph, a brief description is made of how to check with the existing standard procedures whether a UE, in connected or idle mode, is reachable or not.
For a UE in connected mode, as long as there is an exchange of signaling and/or data between the UE and the cell, then the UE is considered as reachable.
For a UE in idle mode, for the network to know whether the UE is still receiving radio coverage from a serving cell or whether it went out-of-coverage, existing paging procedures might be used as follows: The wireless network will send paging messages periodically to the UE, where the period could be few seconds up to many minutes, then
   As long as the paging is answered by the UE, the UE will be considered as reachable.
   If the UE does not respond to a predefined amount of paging, e.g. the UE went underground where there is no radio coverage, then the UE will be considered as non-reachable.
      (Procedure 2) works as follows: After the radio access network has received beforehand_sensor_notif the main objective of (Procedure 2) is to make the radio access network keeps tracking the reachability, or say radio coverage availability, of the UE, e.g. UE1, that has sent beforehand_sensor_notif. Then one of the following two actions are taken:
As long as UE1 is reachable, no further action is taken by the radio access network.
Otherwise, the radio access network will trigger, as described in next step 21, the activation of UE-to-UE wireless communication on all UEs surrounding UE1.
   It should be noted that the tracking of UE1 reachability could be performed via any existing software entity, implemented at OSS or on a remote server used to track UE reachability. In this document, such entity is denoted as OSS_entity_tracking_UE.
   The most common technologies used for UE-to-UE wireless communication, are:
1—sidelink
2—Bluetooth
3—Near link
   To execute (Procedure 2), that is to achieve UE-to-UE wireless communication after UE1 is left out of coverage two main actions are performed as follows,
(Action 1), as described in next step 21, is executed at the UE side.
(Action 2), described in step 22 below, is executed on the network side.
   At step 21:
   Based on actual standards, when UE1 goes out of coverage, sidelink communication can be systematically enabled. A proposed feature can consist of making UE1 also enable, any other available UE-to-UE wireless communication can be implemented at UE1, e.g. Bluetooth, near link etc.
   The intention of activating all the implemented UE-to-UE wireless communication technologies at UE1 is to allow the remote UE1 that is left out of network coverage to be able to connect, via any existing UE-to-UE wireless communication technologies, with another UE, e.g. UE2, that is located on a running neighboring cell, e.g. cell2. This is done because the neighboring UE2, which could be an old device, might not have sidelink implemented on it.
   As is the case with sidelink technology, if any other technology, e.g. Bluetooth is triggered at UE1, then a new message, e.g. ‘I am here in an emergency’ is broadcasted via Bluetooth message to all nearby UEs, e.g. UE2, that have Bluetooth enabled on their side. This is done so that UE2 can respond to the Bluetooth message that is broadcasted by UE1. The intention here is to allow emergency communication between UE1 and UE2 and hence any authentication procedure between UE1 and UE2 is not needed or is not triggered. In other words, even when UE1 and UE2 do not know each other they could still exchange some messages during emergencies.
   A new mobile application might be implemented at the UE and allow the subscriber to manage the UE-to-UE wireless communication between two UEs. In one example, thanks to such a mobile application, any reader of that application on one UE, e.g. UE1, could know how far, e.g. 150 meters away, the other connected UE, e.g. UE2. In another example, such a mobile application will allow a subscriber to write a text message or record a voice message to be sent via Bluetooth or any other enabled UE-to-UE wireless communication technology.
   At step 22:
   Each time the network receives beforehand_sensor_notif from UE1, OSS_entity_tracking_UE will check the reachability of that UE1 or say the radio connection between UE1 and the network, then take one of the following two actions:
As long as UE1 is reachable from the network, then no further action is taken by the network.
As soon as UE1 becomes not reachable, then a new command, or say a new parameter, is communicated to all the UEs that are close to UE1 so that they activate UE-to-UE wireless communications. For that purpose, a new parameter, denoted as activate_UE_to_UE_communication and coded into a few bits, has to be communicated by the wireless network, to the UEs. Following are some examples of the meaning of the bits of this parameter in case for instance it is coded into three bits:
   111 activate all available UE-to-UE wireless communication technologies available at the UE.
   000 deactivate all available UE-to-UE wireless communication technologies at the UE.
   001 activate sidelink only.
   010 activate Bluetooth only.

### And so on.

The value of the parameter activate_UE_to_UE_communication could be communicated by the network to the UEs in one of the following four ways:
1—Via cell broadcasted signaling, e.g. in one existing SIB (System Information Block).
2—Via dedicated signaling, e.g. via any RRC (Radio Resource Control) signaling message.
   Note that for any of the above two ways to work, the new parameter activate_UE_to_UE_communication has to be added to the actual standards.
3—It could be sent to a new mobile application, e.g. denoted mobile_app_UE_to_UE_communication implemented at the other UEs.

The advantage of this way over the first two ways is that it does not require a standard change as the new parameter is transmitted in the data between the mobile application and its server. A new link is required to connect the software entity for tracking the reachability of a UE to the server of the sensor mobile application. Such a new link could be any existing link, e.g. IP (Internet Protocol) over Ethernet or fiber.
4—Sending a broadcast SMS (Short Message Service) to the UEs. Here the role of mobile_app_UE_to_UE_communication is to extract the contents of the SMS and translate it into activating the one or multiple UE-to-UE wireless communication technologies listed in the received activate_UE_to_UE_communication parameter.
   At step 23:
   The new parameter could be communicated to,
1—All UEs as described in following step 23-1.
2—Or to some selected UEs, as described in step 23-2 below.
   Step 23-1: The new parameter is sent to all UEs
   To communicate the new parameter, activate_UE_to_UE_communication, to all UEs, existing methods are used. In one example, the new parameter is broadcasted by the cell to all UEs in the cell via one SIB (System Information Block). In a second example, for each UE in connected mode, the new parameter is sent in a dedicated signaling message. In a third example, the new parameter is sent to a mobile application implemented on the UE side.
   Step 23-2: The new parameter is sent to some UEs
   Inside beforehand_sensor_notif sent to the radio access network, UE1 inserts its location X when the notification is sent. When the network receives beforehand_sensor_notif then one of the following two procedures is used:
1—(network triggered procedure)
   For each UE that is in connected mode, the network will calculate the actual location Y of the UE and compare it with the location X of UEL that was reported in beforehand_sensor_notif. If location Y of the UE is closed to location X of UE1 by a certain distance d1, then such UE will be then considered as closed to UE1 and the activate_UE_to_UE_communication parameter is communicated to it, via one of the above four ways described in the above step 22. Otherwise, the activate_UE_to_UE_communication parameter is not communicated to the UEs far from UE1. Note that the value of d1 might be a predefined configured value at the UE and might change depending on the UE-to-UE wireless communication technology that is being used, e.g. for sidelink d1 might be equal to 1 km whereas for Bluetooth it is equal to a few hundred meters.
2—(UE triggered procedure)
   Once the network receives beforehand_sensor_notif it will extract location X of UE1 and communicate it to the other UEs via one of the above four ways, e.g. via cell broadcast etc. It is then up to each UE to calculate its location Y and compare it, as was the case with the previous network-triggered procedure, with location X within a distant d1 then make the decision on whether to activate or not UE-to-UE wireless communication technology on its side.

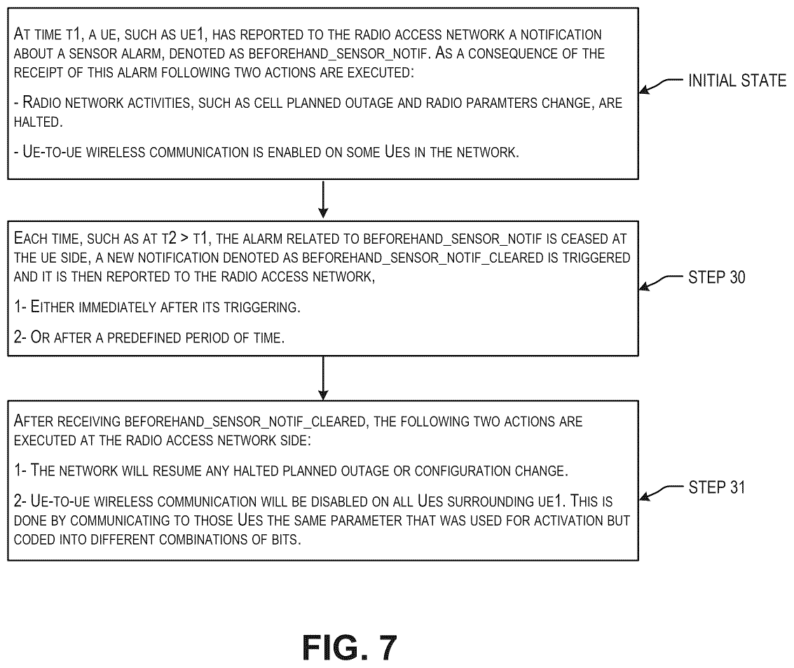

FIG. 7 illustrates an exemplary representation of steps for a network reaction after receiving the clearance of a sensor alarm by the proposed method, in accordance with an embodiment of the present disclosure.

Referring to FIG. 7, in an embodiment, steps for a network reaction after receiving the clearance of a sensor alarm by the proposed method are disclosed.

At an initial state:
At time t1, a UE, e.g. UE1, has reported to the radio access network a notification about a sensor alarm, denoted as beforehand_sensor_notif. As a consequence of the receipt of this alarm, the following two actions can be executed by the radio access network:
Radio access network activities, such as cell planned outages and radio parameters change, can be halted.
UE-to-UE wireless communication can be enabled on some UEs in the network.

### At Step 30:

Each time the sensor alarm beforehand_sensor_notif is ceased at the UE side then at this step a new sensor alarm notification, denoted here as beforehand_sensor_notif_cleared, is triggered. However, when to report this new notification to the radio access network will depend on the expiry of a new timer that is preconfigured at the UE which in turn depends on the type of the alarm that has been cleared. In all cases, the reporting of beforehand_sensor_notif_cleared might be performed in one of the following two options:
1—Immediately after its triggering.
2—After a preconfigured timer has expired. In one example if the alarm was a fire, a preconfigured timer value might be equal to a few hours, e.g. 3 hours. In other words, if the fire alarm is cleared say at time t1, beforehand_sensor_notif_cleared is not sent to the radio access network before 3 hours have elapsed from t1. Such delay in sending beforehand_sensor_notif_cleared is done so that no network action, e.g. planned cell outage, is executed during this 3 hours period. The reason is that, within 3 hours of the fire extension, some subscribers might still be in a dangerous situation due to the result of that fire and it is disturbing to cut their ongoing calls, especially in case of emergency calls.
   Note at the same time beforehand_sensor_notif_cleared is reported to the radio access network it could also be reported to its preconfigured target destination, e.g. a firefighter station or a doctor etc., to notify them about the clearance of a previously reported beforehand_sensor_notif.

### At Step 31:

After receiving beforehand_sensor_notif_cleared, the following two actions can be executed at the radio access network side:
1—The network can resume any halted planned outage or configuration change.
2—UE-to-UE wireless communication can be disabled on all UEs surrounding UE1. This can be done by communicating to those UEs the same parameter, activate_UE_to_UE_communication, used for activation but coded into different combinations of bits, e.g. activate_UE_to_UE_communication=000.

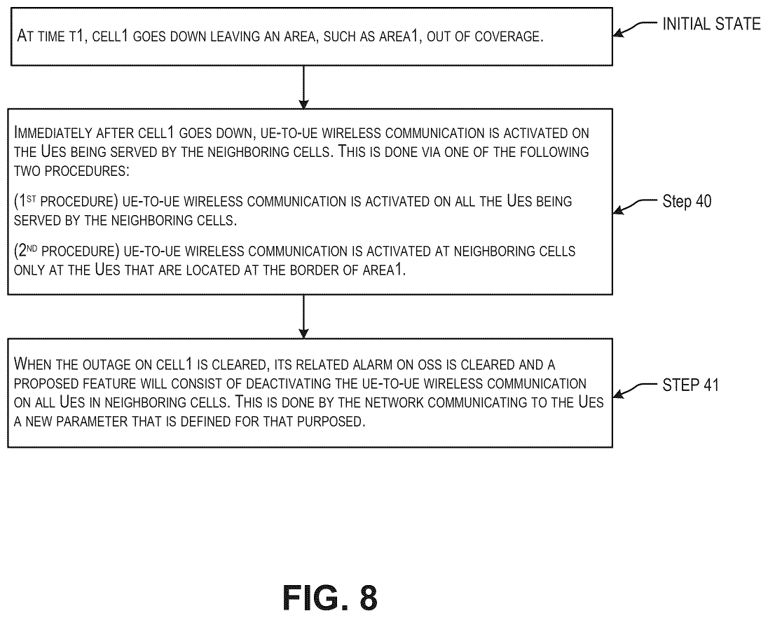

FIG. 8 illustrates an exemplary representation of steps for activation of UE-to-UE wireless communication each time a cell goes down, in accordance with an embodiment of the present disclosure.

Referring to FIG. 8, in an embodiment, steps for activation of UE-to-UE wireless communication each time a cell goes down are disclosed.

At an initial state:
At time t1, cell1 goes down leaving an area, e.g. area1, out-of-coverage.
So far, one requirement for triggering UE-to-UE wireless communication on neighboring UEs is that one UE, e.g. UE1, has sent a beforehand_sensor_notif to the radio access network. In other words, UE1 was receiving radio coverage from one cell, e.g. cell1, at the time of the sensor alarm activation and as a consequence UE1 was able to transmit beforehand_sensor_notif. However, the following scenario might occur: At time t2, cell1 goes into an outage leaving an area, e.g. area1, out-of-coverage, and later at time t3 while cell1 is still down, a second UE, UE2, located in area1 has a sensor alarm being activated. As UE2 has no radio coverage, it cannot transmit beforehand_sensor_notif to the radio access network to notify it about the new alarm on UE2 nor can it transmit the legacy sensor alarm to its target destination, e.g. a firefighter station or a doctor, etc. To overcome such a problem, a new feature composed of the following steps 40 and 41 is introduced.
At step 40:
Immediately after the cell1 goes down, UE-to-UE wireless communication can be activated on the UEs being served by the neighboring cells. This can be done via one of the following two procedures:
(1^{st} procedure) UE-to-UE wireless communication can be activated on all the UEs being served by the neighboring cells. Each time a cell, e.g. cell1 covering one area, e.g. area1, goes down, the OSS can identify all the neighbors of cell1 and then it can send a command to all the neighbors of cell1 so that they activate UE-to-UE wireless communication on the UEs being served by them. This can be done by the wireless network communicating to the UEs, the parameter activate_UE_to_UE_communication being equal to 111 where the value 111 can mean each receiver UE can activate all its available UE-to-UE wireless communication technologies on it. Option of 111 can be selected because the network cannot know in advance what type of UE-to-UE wireless communication technology is available on the non-reachable UE located in the area1.
(2^{nd} procedure) UE-to-UE wireless communication can be activated at neighboring cells only at the UEs located at the border of the area1. It can be activated through the following two options:
(Option 1): Each UE being served by a neighbor cell of cell1, e.g. cell2, and that experiences bad radio coverage, e.g. below a predefined RSRP threshold, denoted here as RSRP_threshold e.g. −100 dbm, can be considered as a ‘potential’ UE located at the border of area1. It can be a ‘potential’ because other UEs served by cell2 can also experience bad radio coverage without being at the border of area1, e.g. a UE located in the middle of area2 covered by cell2 could experience bad radio coverage while moving towards the underground where there is no radio coverage. (Option 2): To exclude the UEs that can experience bad radio coverage while being located at the center of the neighboring cells, e.g. in the area2 of our example in Option 1, and as a second option, in addition to RSRP_threshold, another parameter based on TA (Timing Advance) of the UE and denoted TA_threshold can be considered. This is done as follows: Actually, when a cell goes down, different existing procedures are used to estimate the size of the impacted area, that is area1 of cell1 in our example, and as a result information about area1 will be known by the network. This includes the geographical coordinate of area1, the RSRPi and the TAi of each UEi that has passed by the border of area1 and that was involved in the building of the size of area1. Based on TAi values, the network could select one value or a range of values for TA_threshold that define the border of the area1. In conclusion, with this second option, the UEs considered as being located at the border of the area1 are the UEs that validate two conditions: their RSRPi is <RSRP_threshold AND their TAi<TA_threshold.
At step 41:
When the outage on the cell1 is cleared, its related alarm on OSS can be cleared and a proposed feature will consist of deactivating the UE-to-UE wireless communication on all UEs in neighboring cells. This can be done by the network communicating to the UEs activate_UE_to_UE_communication=000 to all UEs in neighboring cells through one of the four ways described above which can be:
1—Through cell broadcasted signaling, e.g. in one existing System Information Block (SIB).
2—Through dedicated signaling, e.g. through the use of any Radio Resource Control (RRC) signaling message.
3—Can be sent to a new mobile application, e.g. denoted mobile_app_UE_to_UE_communication implemented at the other UEs.
4—By sending a short message to the other UEs the mobile_app_UE_to_UE_communication can extract the contents of that short message.

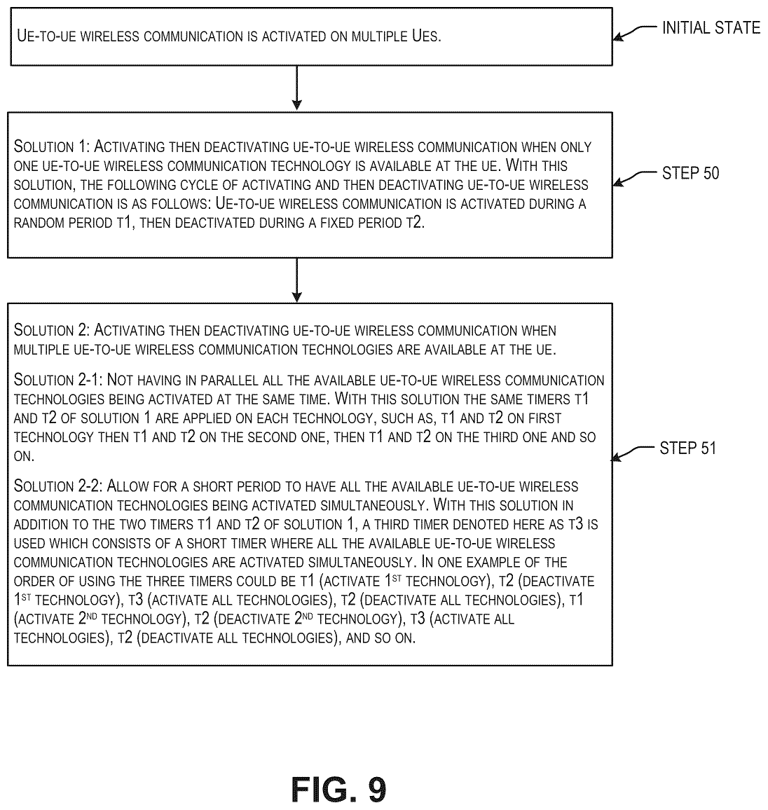

FIG. 9 illustrates an exemplary representation of steps to instruct the UEs about the duration to activate UE-to-UE wireless communication by the proposed method, in accordance with an embodiment of the present disclosure.

Referring to FIG. 9, in an embodiment, steps to instruct the UEs about the duration to activate UE-to-UE wireless communication by the proposed method are disclosed.

The objective of the below steps is to overcome the issue which is to for how long UE2 has to keep activating the UE-to-UE wireless communication after a UE, e.g. UE2, on a cell, e.g. cell2, has received at the time, e.g. t1, activate_UE_to_UE_communication=111. If UE2 cannot be connected to a UE, UE1, in area1 that is left out-of-coverage, then it might be inefficient to keep Bluetooth and sidelink and other UE-to-UE wireless communication technologies being activated continuously until the UE-to-UE wireless communication is deactivated on UE2 at time t2>t1 where t2−t1 might vary between few seconds up to few hours depending on the issue that has caused UE1 to be left out-of-coverage.
At an initial state:
UE-to-UE wireless communication can be activated on multiple UEs.
To tell the UEs how long they have to activate UE-to-UE wireless communication, two solutions, solution 1 and solution 2, are proposed where solution 1 is described in Step 50 and solution 2 is described in Step 51.
At step 50:
Solution 1: Activating then deactivating UE-to-UE wireless communication when only UE-to-UE wireless communication technology is available at the UE
With this solution, new timers, two denoted respectively as timer_activate_UE_to_UE_communication and sleep_timer_activate_UE_to UE_communication can be defined at the UE side, e.g. UEx. Their values can be in units of seconds. Once UEx receives activate_UE_to_UE_communication it can multiply the first new timer, timer_activate_UE_to_UE_communication by a random value which can take any value between 0 and 1. The result of such multiplication can be denoted here as T1. UEx can then activate UE-to-UE communication during that T1 period. At the expiry of T1, UEx can deactivate UE-to-UE communication for a period defined in sleep_timer_activate_UE_to_UE_communication. After the expiry of sleep_timer_activate_UE_to_UE_communication, UEx can start again a new value of T1, e.g. denoted T1_1, by multiplying again timer_activate_UE_to_UE_communication with a newly generated random value. After the expiry of T1_1, UEx can deactivate UE-to-UE wireless communication. The role of the random value can be to spread the duration of activation of UE-to-UE communication among the UEs that have received the command activate_UE_to_UE_communication=111. An advantage of such spreading can be that while UEx has deactivated its UE-to-UE wireless communication during sleep_timer_activate_UE_to UE_communication, a second UE, e.g., UEy can have the UE-to-UE wireless communication activated on its side and UE1 left in an out-of-coverage can get a chance to communicate with UEy while UEx is in sleep mode.
At step 51:
Solution 2: Activating the deactivating UE-to-UE wireless communication when multiple UE-to-UE wireless communication technologies are available at the UE If UEx that has received activate_UE_to_UE_communication=111 has more than two UE-to-UE wireless communication technologies that can be implemented at the UE, e.g. it can have three of them which are sidelink, Bluetooth and Near link, solution 2 can consist of one of the following two solutions:
Solution 2-1: Not having in parallel all the available UE-to-UE wireless communication technologies being activated at the same time.
With this solution the same timers T1 and T2 of Solution 1 are applied on each technology, e.g. T1 & T2 on the first technology then T1 & T2 on the second one then T1 & T2 on the third one and so on. The UE can randomly select one of the three systems first, e.g. it selects a first technology e.g. Bluetooth, then solution 1 can be applied, that is activate Bluetooth for a short period equal to T1 then go into sleep mode, then it can randomly select a second technology, e.g. sidelink and apply solution 1, then it can choose a third technology, e.g. near link, and apply solution 1, and can then repeat solution 1 on each of them with the same order that was done before, that can be Bluetooth, sidelink and near link, or select the order of each technology randomly at each repeated pattern.
Solution 2-2: Allow for a short period to have all the available UE-to-UE wireless communication technologies being activated simultaneously.
With this solution in addition to the two timers T1 and T2 of Solution 1 a third timer, denoted here as T3, is a short timer where all the available UE-to-UE wireless communication technologies are activated simultaneously. One example of the order of using the three timers could be T1 (activate 1^{st} technology), T2 (deactivate 1^{st} technology), T3 (activate all technologies), T2 (deactivate all technologies), T1 (activate 2^{nd} technology), T2 (deactivate 2^{nd} technology), T3 (activate all technologies), T2 (deactivate all technologies) etc.
During T1 only one UE-to-UE wireless communication technology can be activated, e.g. sidelink, whereas, during T3 all available UE-to-UE wireless communication technologies can be activated at the same time. Different cycle periods of the three timers can be configured. Each activation of one or more UE-to-UE wireless communication technologies can be followed by a deactivation, and, after the activation/deactivation (T1 then T2) of one technology, the activation/deactivation of all technologies (T3 then T2) can be followed.

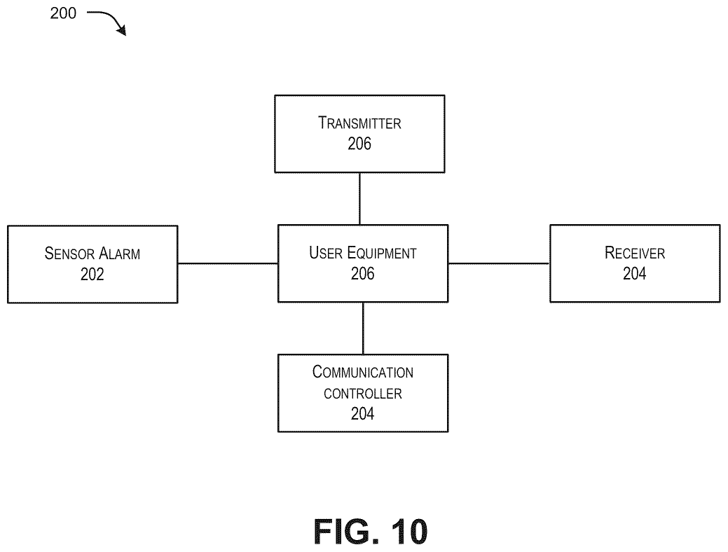

FIG. 10 illustrates an exemplary block diagram of a system to control a sensor alarm and facilitate UE-to-UE communication in a radio access network (RAN), in accordance with an embodiment of the present disclosure.

Referring to FIG. 10, in an embodiment, a system 200 to control a sensor alarm 202 and facilitate UE-to-UE communication in a radio access network (RAN) is disclosed. The system 200 can include a receiver 204 configured to receive an early notification of the sensor alarm 202 from a first user equipment (UE) 206 within a predefined margin, and a communication controller 208 in communication with the first UE 206 and configured to terminate one or more scheduled or ongoing network activities impacting call performance of a UE upon receipt of the early notification of the sensor alarm 202 and initiate and maintain tracking of the reachability of the first UE 206 by the radio access network. Further, the system 200 can include a transmitter 210 configured to send a command from the radio access network to one or more surrounding UEs instructing activation of UE-to-UE wireless communication upon unreachability of the first UE 206.

In an exemplary embodiment, a sensor alarm is a device that uses an optical, microwave, or acoustic sensor to detect motion. A receiver is an electronic device that receives radio waves and converts the information carried to a usable form. A communication controller manages the communication of input/output data in a network and facilitates user tracking of all network activities. A transmitter is a device that generates radio waves from an antenna to send and receive data.

The user equipment can be a smartphone, tablet computer, portable media device or the like.

Therefore, the proposed method and system provides controlling a sensor alarm and facilitating UE-to-UE communication in a radio access network (RAN) by determining the duration of UE-to-UE communication activation and selecting the appropriate wireless communication technologies for activation.

It will be apparent to those skilled in the art that the method of the disclosure may be provided using some or all of the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Present Disclosure

The present disclosure provides a method that enables the radio access network to receive early notifications of sensor alarms and promptly terminate network activities impacting call performance to ensure swift responses to critical events. This minimizes potential delays in addressing sensor alarms, improving overall system responsiveness.

The present disclosure provides a method that enables initiating and maintaining tracking of the reachability of the UE that has reported the early notification of sensor alarms to enable the system to ensure continuous communication capabilities. This enhances the reliability of alarm transmission and facilitates timely responses, even when network connectivity is compromised.

The present disclosure provides a method that enables the activation of UE-to-UE wireless communication technologies in response to UE unreachability enhancing communication redundancy. This provides an alternative communication channel, ensuring the uninterrupted transmission of critical alarm information.

The present disclosure provides a method that enables the activation of UE-to-UE communication in neighboring cells during cell outages and deactivating it upon outage recovery to enhance network resilience. This ensures continuous communication capabilities, mitigating the impact of network disruptions on critical alarm transmission.

The present disclosure provides an efficient solution with an AI and ML entity at the UE side that enables the UE to guess whether, around the time the UE has reported to the radio access network an early sensor alarm notification, there is an ongoing network activity that could impact call performance at the radio access side.

The present disclosure provides an efficient solution that obviates the existing limitations by determining the duration of UE-to-UE communication activation and selecting the appropriate wireless communication technologies for activation.

I claim:

1. A method (100) for reporting a sensor alarm and facilitating UE-to-UE communication in a radio access network (RAN), said method (100) comprising:
receiving within a predefined margin, an early notification of the sensor alarm from a first user equipment (UE);
terminating one or more scheduled or ongoing network activities impacting call performance of a UE upon receipt of the early notification of the sensor alarm;
initiating tracking of reachability of the first UE by the RAN; and
continuing tracking of reachability of the first UE by the RAN,
wherein, if the first UE remains reachable no further action is taken by the RAN, and if the first UE becomes unreachable send a command from the RAN to one or more surrounding UEs instructing them to activate UE-to-UE wireless communication.

2. The method (100) as claimed in claim 1, wherein the early notification of the sensor alarm is reported to the radio access network based on one or more predicted occurrences of sensor alarm coinciding with presumed RAN activities or upon reaching predetermined thresholds of one or more sensor alarm levels.

3. The method (100) as claimed in claim 2, wherein the predicted occurrences of sensor alarm coinciding with presumed RAN activities is performed by an artificial intelligence and machine learning software entity that is implemented at the UE side and wherein that entity,
stores in a first log the timestamp and location each time the UE has experienced radio cell outage or radio network degradation,
stores in a second log the timestamp and location when the sensor alarm has been activated,
compares the common information between the first and second log,
then reports an early notification of the sensor alarm if the common information validates a predefined condition.

4. The method (100) as claimed in claim 1, wherein activation of UE-to-UE wireless communication technologies comprises activating available technologies on the first UE and transmitting a command by the radio access network to the one or more surrounding UEs specifying the type of communication technology to activate.

5. The method (100) as claimed in claim 1, wherein the first UE is considered unreachable if it fails to respond to repeated paging requests in inactive mode or loses radio link connection in connected mode.

6. The method (100) as claimed in claim 1, wherein the RAN comprises a cell, a radio node, and an Operation Support System (OSS) having one or more software entities for tracking the reachability of the UE that has reported sensor alarm.

7. The method (100) as claimed in claim 1, wherein termination of a reported sensor alarm triggers a clearance notification from the UE to the network, either immediately or after a predefined period.

8. The method (100) as claimed in claim 1, wherein clearance of the sensor alarm triggers a second sensor alarm notification, prompting network activity resumption and UE-to-UE communication deactivation.

9. The method (100) as claimed in claim 1, wherein UE-to-UE wireless communication is activated in one or more neighboring cells on all the UEs being served by the one or more neighboring cells or at the UEs located at a border of a first area of a first cell and when outage on the first cell is recovered, UE-to-UE wireless communication is deactivated on all the UEs in one or more neighboring cells of the first cell.

10. The method (100) as claimed in claim 1, wherein activation and deactivation of multiple UE-to-UE communication technologies occur sequentially or simultaneously based on a set of predefined patterns or timers.

11. A system (200) to report sensor alarm (202) and facilitate UE-to-UE communication in a radio access network (RAN), said system (200) comprising:
a receiver (204) configured to receive an early notification of the sensor alarm (202) from a first user equipment (UE) (206) within a predefined margin;
a communication controller (208) in communication with the first UE (206) and configured to:
terminate one or more scheduled or ongoing network activities impacting call performance of a UE upon receipt of the early notification of the sensor alarm (202); and
initiate and maintain tracking of the reachability of the first UE (206) by the radio access network; and
a transmitter (210) configured to send a command from the radio access network to one or more surrounding UEs instructing activation of UE-to-UE wireless communication upon unreachability of the first UE (206).
